(19) United States
(12) Patent Application Publication
(10) Pub. No.: US 2006/0106470 A1
(43) Pub. Date: May 18, 2006

(54) Remote control system and its transmitter and movable machine

(75) Inventor: Ryoji Hayashi, Tokyo (JP)

Correspondence Address: DARBY & DARBY P.C., P. O. BOX 5257, NEW YORK, NY, 10150-5257, US

(73) Assignee: Konami Corporation, Tokyo (JP)

(21) Appl. No.: 10/524,305

(22) PCT Filed: Aug. 8, 2003
(86) PCT No.: PCT/JP03/10177

§ 371 Date: Sep. 6, 2005

(30) Foreign Application Priority Data
Aug. 12, 2002 (JP) 2002-235181

(51) Int. Cl. G05B 19/18

(52) U.S. Cl. 700/65; 700/66

(57) ABSTRACT

A remote control system is provided that prevents a combination of a transmitter and a movable machine other than a combination determined in the system from being established, ensures fair fighting games, and is capable of easily discriminating a movable machine and a transmitter combined in the system even when combinations cannot be discriminated visibly.

A transmitter 2 reads characteristic information 10 from a recording medium 3 having the characteristic information associated with a movable machine 1 recorded thereon, and transmits the information to the movable machine 1 as initial data. If the received characteristic information coincides with characteristic information 16 the movable machine has, then the movable machine 1 comes in a state to ready to operate. Even if movable data destined to the movable machine 1 itself is transmitted, however, the movable machine 1 is not activated until the initial data containing the characteristic information 16 is received. The above described problem is solved by such a remote control system.

### TECHNICAL FIELD OF THE INVENTION

The present invention relates to a remote control system in which a movable machine is remote-controlled on the basis of moving information transmitted from a transmitter.

### BACKGROUND OF THE INVENTION

In remote control systems for controlling a movable machine on the basis of moving information transmitted from a transmitter, there is a remote control system in which a difference is provided in performance from movable machine to movable machine in order to increase the user's interest when the movable machines are made to compete with each other. For example, in the case of a remote control system in which movable machines are made to fire shells, a difference is provided in each of power of main gun, charging time, and the number of shells from movable machine to movable machine. Among such remote control systems, there is already a remote control system in which the transmitter side manages a part, such as the number of shells and the charging time when the movable machines are tanks, of information concerning the performance of movable machines for the purpose of suppressing the system complication and the production cost.

In the remote control system, however, it becomes possible to control a certain movable machine even when a transmitter other than a transmitter having performance information corresponding to the movable machine is used. Because a combination of a transmitter and a receiver is managed by ID information alone and consequently it is impossible for a movable machine to discriminate a transmitter when ID information is the same. Therefore, a movable machine having performance different from that of a movable machine provided on the system is established. Especially if a movable machine having high performance alone is established, a fair fighting game cannot be played, resulting in a hindrance.

Furthermore, it is difficult to discriminate a specific movable machine and a transmitter combined with the movable machine as a transmitter for controlling the movable machine (hereafter referred to as “transmitter corresponding to the specific movable machine”) when the combination is not expressed visibly.

### SUMMARY OF THE INVENTION

Therefore, an object of the present invention is to provide a remote control system that prevents a combination of a transmitter and a movable machine other than a combination determined in the system from being established, excludes unfairness such as in fighting games, and is capable of easily discriminating a movable machine and a transmitter combined in the system even when the combinations cannot be discriminated visibly.

The above described problem is solved by a remote control system including a transmitter and a movable machine remote-controlled on the basis of a control signal transmitted from the transmitter, and discriminating at least one combination of the transmitter and the movable machine to be controlled by the transmitter on the basis of first identification information transmitted from the transmitter, wherein the remote control system includes a recording medium having characteristic information associated with the movable machine recorded thereon, the transmitter includes: a characteristic information recognition device capable of recognizing the characteristic information concerning the movable machine to be controlled, recorded on the recording medium; and a second identification information transmission device for transmitting second identification information, which specifies the movable machine as a movable machine to be controlled on the basis of the recognized characteristic information, and the movable machine includes: a discrimination device for determining whether remote control conducted by the transmitter that has transmitted the second identification information is allowed, on the basis of the received second identification information; and a remote control prohibition device responsive to discrimination that the remote control is not allowed, for prohibiting the remote control by the transmitter that has transmitted the second identification information, irrespective of whether the combination based on the first identification information is established.

Thereby, it is determined on the basis of second identification information based on characteristic information to a movable machine whether the transmitter that has transmitted data is a transmitter corresponding to the movable machine. Until it is judged that data from the corresponding transmitter has been received, the movable machine does not come into a state ready to operate. In other words, even if data from a transmitter with which a combination is established on the basis of the first information is received, the movable machine does not move unless the movable machine is not in a state ready to operate. As a result, it is possible to implement such a remote control system that a combination of a specific movable machine and a transmitter other than a transmitter determined on the system as a transmitter corresponding to the movable machine is not established. Here, prohibition of remote control includes not only the case where the movable machine does not operate, but also the case where the movable machine does not operate normally. The state ready to operate refers to such a state that the movable machine can normally operate in response to a control signal for conducting ordinary remote control.

The recording medium may be capable of being attached to and detached from the transmitter. Even in the case there are a plurality of movable machines differing in characteristic information, one transmitter can cope with the movable machines by replacing each recording medium having characteristic information of each movable machine recorded thereon.

Furthermore, it is possible that writing into the recording medium cannot be conducted by users. As a result, it is possible to prevent a risk that a combination of a specific movable machine and a transmitter other than the transmitter corresponding to the movable machine will be established by the user's rewriting.

It is possible that the movable machine includes a storage device for storing information based on the characteristic information associated with itself, and the discrimination device determines whether the remote control is allowed on the basis of the stored information based on the characteristic information of itself and the received second identification information.

By only comparing the received second identification information with the information based on its own characteristic information stored in the movable machine, therefore, it can be determined whether the transmitter that has transmitted the second identification information is a transmitter to be controlled corresponding to the movable machine.

The movable machine may include a remote control enabling device remote-controlled on the basis of the first identification information after the discrimination device has judged the remote control to be allowed.

After data has been received from the transmitter corresponding to the movable machine, therefore, the remote control can be conducted on the basis of the conventional first identification information. While keeping the design change on the existing remote control system to the minimum, the present invention can be implemented.

It is possible that the movable machine has a discriminant for determining whether the movable machine should operate on the basis of the control signal, and the remote control enabling device enables the remote control on the basis of the first identification information, by controlling the discriminant. If the content of the discriminant is confirmed, therefore, it can be determined whether the movable machine is in such a state as to be able to be activated by the transmitter.

The remote control system may include an another transmitter excluding device for disabling the remote control conducted by an another transmitter except for the transmitter enabled first by the discrimination device, even if the different transmitter is the transmitter to control the movable machine on the basis of the first identification information. After the movable machine comes into such a state that it can operate, even a transmitter having the first identification information set so that the movable machine will judge data to be intended for the movable machine itself can be excluded if the transmitter has information rewritten favorably.

The another transmitter excluding device may disable remote control conducted by the another transmitter, by using information based on transmission timing of the control signal transmitted by the transmitter. Transmission timing is set on the basis of the first identification information. When there is transmission timing overlapping, a transmitter that attempts to transmit data containing the first identification information later is prevented from transmitting. By such a configuration, a transmitter that is other than a transmitter determined first to be a transmitter corresponding to the movable machine and that has information rewritten favorably can be excluded.

The characteristic information may contain information concerning control laws characteristic to the movable machine associated with the characteristic information, and the transmitter may include a control signal transmission device for creating a control signal based on the control laws and transmitting the created control signal. As a result, it becomes possible for the transmitter to control the movable machine according to the control laws characteristic to the movable machine.

The above described problem is solved by a movable machine moved by a control signal supplied from a transmitter combined with the movable machine on the basis of first identification information, the movable machine including: a recording medium having characteristic information of the movable machine itself recorded thereon; a discrimination device responsive to transmission of second identification information based on the characteristic information transmitted from the transmitter that has recognized the characteristic information through the recording medium, for determining whether remote control conducted by the transmitter that has transmitted the second identification information is allowed, on the basis of the received second identification information; and a remote control prohibition device responsive to discrimination that the remote control is not allowed, for prohibiting the remote control by the transmitter that has transmitted the second identification information, irrespective of whether the combination based on the first identification information is established. The movable machine is associated with only a transmitter that has transmitted the movable machine's own characteristic information. The movable machine is not controlled from a different transmitter irrespective of the first identification information. By using the movable machine, the remote control system of claim 1 can be implemented.

The recording medium may be separated from the movable machine. As a result, it becomes possible to mount only a recording medium having characteristic information of the movable machine recorded thereon, on the transmitter and use it.

Furthermore, the discrimination device may determine whether remote control conducted by the transmitter that has transmitted the second identification information is allowed, on the basis of information based on the characteristic information retained by itself and the received second identification information. Since it can be determined on the basis of the characteristic information the movable machine has whether the movable machine comes in a state ready to operate, system complication can be avoided.

The above described problem is solved by a transmitter capable of remote-controlling a movable machine combined with the transmitter as a control object on the basis of first identification information, the transmitter including: a characteristic information recognition device capable of recognizing characteristic information of the movable machine recorded on a recording medium; and a second identification information transmission device for transmitting second identification information, which specifies the movable machine as a movable machine to be controlled, on the basis of the recognized characteristic information. Besides the first identification information, the transmitter can send information characteristic to the movable machine to the movable machine as the second identification information, which indicates the transmitter itself is a transmitter that should control the movable machine. By using the transmitter, the remote control system of claim 1 can be implemented.

The above described problem is solved by a remote control system including a transmitter and a movable machine remote-controlled on the basis of a control signal transmitted from the transmitter, wherein the remote control system includes a recording medium having characteristic information associated with the movable machine recorded thereon, the transmitter includes: a characteristic information recognition device for recognizing the characteristic information associated with the movable machine to be controlled; and a movable machine specification information transmission device for transmitting movable machine specification information that specifies the movable machine as a movable machine to be controlled, on the basis of the recognized characteristic information, and the movable machine includes: a discrimination device for determining whether remote control conducted by the transmitter that has transmitted the movable machine specification information is allowed, on the basis of the received movable machine specification information; and a remote control prohibition device responsive to discrimination that the remote control is not allowed, for prohibiting the remote control by the transmitter that has transmitted the movable machine specification information.

When a specific movable machine and a transmitter corresponding to the movable machine is determined in the system, therefore, a movable machine and a transmitter combined in the system can be easily discriminated even if the combination cannot be visibly discriminated. The prohibition of the remote control includes the case where the movable machine does not operate normally according to remote control.

Furthermore, it is possible that the recording medium can be attached to and detached from the transmitter. When there are a plurality of movable machines differing in characteristic information, one transmitter can cope with the movable machines by replacing each recording medium having characteristic information of each movable machine recorded thereon.

The characteristic information may include information concerning control laws characteristic to the movable machine associated with the characteristic information, and the transmitter may include a control signal transmission device for creating the control signal based on the control laws and transmitting the created control signal. As a result, it becomes possible for the transmitter to control the movable machine according to the control laws characteristic to the movable machine. The control laws have been described above.

The above described problem is solved by a movable machine moved by a control signal supplied from a transmitter, the movable machine including: a recording medium having characteristic information of the movable machine itself recorded thereon;

a discrimination device responsive to transmission of identification information based on recognized characteristic information transmitted from the transmitter that has recognized the characteristic information from the recording medium, for determining whether remote control conducted by the transmitter that has transmitted the identification information is allowed, on the basis of the received identification information; and a remote control prohibition device responsive to discrimination that the remote control is not allowed, for prohibiting the remote control by the transmitter that has transmitted the identification information. It is possible to prevent the movable machine from being associated with a transmitter other than the transmitter that has transmitted characteristic information of itself. By using the movable machine, the remote control system of claim 14 can be implemented.

The recording medium may be separated from the movable machine. As a result, it becomes possible to mount a recording medium having characteristic information of the movable machine recorded thereon, on the transmitter and use it.

The discrimination device may determine whether the remote control conducted by the transmitter that has transmitted the identification information is allowed, on the basis of information based on the characteristic information of itself and the received identification information. Since it can be determined on the basis of only the characteristic information the movable machine has whether the remote control can be conducted, system complication can be avoided.

The above described problem is solved by a transmitter capable of remote-controlling a movable machine, the transmitter including: a characteristic information recognition device capable of recognizing characteristic information of the movable machine recorded on a recording medium; and an identification information transmission device for transmitting identification information, which specifies the movable machine as a movable machine to be controlled on the basis of the recognized characteristic information. The transmitter can send information characteristic to the movable machine to the movable machine as identification information, which indicates the transmitter itself is a transmitter that should control the movable machine. By using the transmitter, the remote control system of claim 14 can be implemented.

### BRIEF DESCRIPTION OF THE DRAWINGS

FIG. 1 shows an example of a configuration of a remote control system in the present invention;

FIG. 2 shows how a vehicle recognition ROM is attached to a recording medium mounting section provided on a transmitter;

FIG. 3 shows contents of data recorded respectively in a vehicle recognition ROM and a tank model as information characteristic to the tank model, and relations between those data and hardware used in the present embodiment;

FIG. 4 shows a circuit configuration of a transmitter in the present embodiment;

FIG. 5 shows a circuit configuration of a tank model in the present embodiment;

FIGS. 6A and 6B are diagrams showing examples of tank models that are different in performance with respect to firing, in which FIG. 6A shows data retained in a nonvolatile memory incorporated in each tank model, and FIG. 6B shows data retained in a vehicle recognition ROM corresponding to each tank model;

FIG. 7 shows processing flows respectively of a tank model and a transmitter after a circuit for power supply is thrown in; and

FIG. 8 shows a processing flow in typical remote control of a tank model.

### DETAILED DESCRIPTION OF THE INVENTION

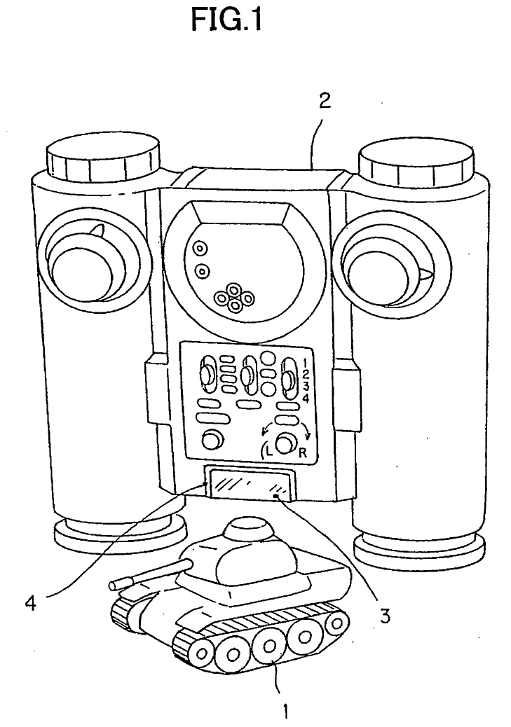

FIG. 1 shows an example of a configuration of a remote control system in the present invention. In the system, a movable machine 1 is controlled by data transmitted from a transmitter 2 by using infrared rays. On the transmitter 2, there is provided a recording medium mounting section 4, which is a place for mounting a detachable recording medium 3 (hereafter referred to as “vehicle recognition ROM 3”) thereon.

In the present embodiment, the movable machine 1 is supposed to be a tank model. Hereafter, the movable machine 1 is referred to as a tank model 1. When there are a plurality of tank models 1 . . . 1 and transmitters 2 . . . 2 respectively for remote-controlling the tank models 1 . . . 1, it is possible to play a game in which the tank models 1 . . . 1 fire shells to each other and compete with each other for a smaller size of damages they sustain.

A mechanism of remote control in a remote control system utilizing infrared rays used in the present embodiment will now be described. In the present embodiment, an ID number is used as the first identification information. A tank model 1 and a transmitter 2 for remote-controlling the tank model 1 have the same ID number. Each ID number is set for a transmitter 2 and a tank model 1. The transmitter 2 can remote-control a tank model 1 having the same ID number as its own ID number. In other words, the transmitter 2 makes data to be transmitted contain its own ID number. If an ID number contained in received data coincides with its own ID number, then the tank model 1 judges the data to be data directed to itself and it is controlled by data contained in the received data.

One ID number is used for only one combination of a tank model 1 to be used and a transmitter 2 corresponding to the tank model 1. It is impossible to remote-control simultaneously two or more sets each including a tank model 1 and a transmitter 2 corresponding to the tank model 1, by using the same ID number. Because transmission timing of a signal transmitted from a transmitter 2 is determined according to an ID number, and the transmitters 2 are designed so that two transmitters 2 may not transmit simultaneously data containing the same ID number. In the present embodiment, ID numbers ranging, for example, 1 to 4 are prepared. Therefore, up to four tank models 1 . . . 1 can be made to fight at the same time.

The movable machine 1 in the present invention is not limited to the tank model 1, but it may also be an airplane, a submarine, or an automobile. Furthermore, the movable machine 1 is not limited to a vehicle, but it needs only be a model that operates according to remote control. Furthermore, in the remote control system in the present embodiment, infrared rays are used as information carriers, but the remote control system may also use other rays or radio waves. The method for controlling a plurality of movable machines 1 . . . 1 at the same time is not limited to the method of setting different transmission timing points, but carriers of different frequencies may also be used.

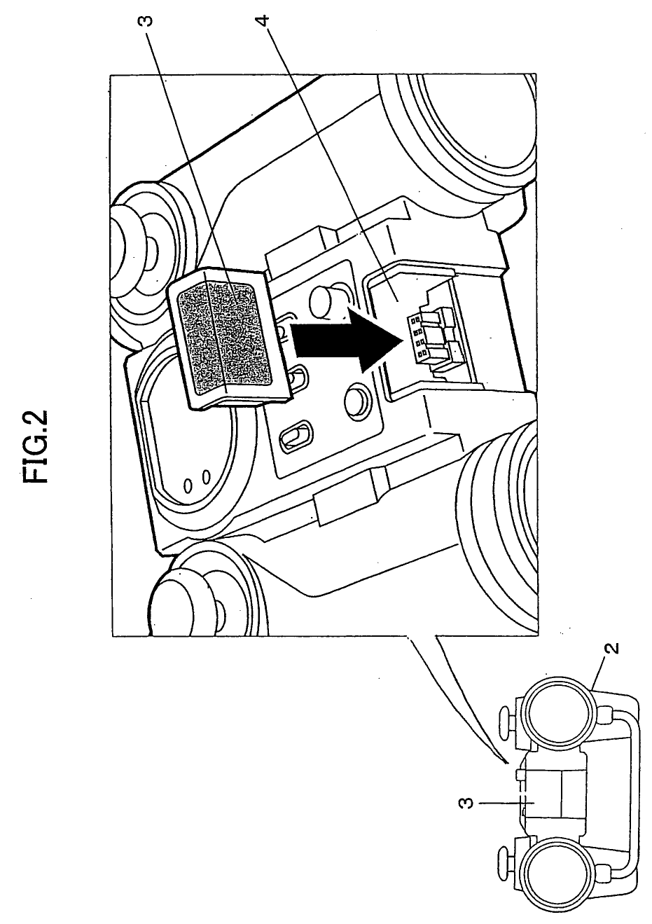

FIG. 2 shows how the vehicle recognition ROM 3 is attached to the recording medium mounting section 4 provided on the transmitter 2. The vehicle recognition ROM 3 is a ROM for making the transmitter 2 recognize a characteristic of the tank model 1. In the present embodiment, the vehicle recognition ROM 3 is utilized as a recording medium on which characteristic information associated with the tank model 1 has been recorded. Unless the vehicle recognition ROM 3 is not mounted on the transmitter 2, the transmitter 2 does not function normally.

As for the tank model 1, there are a plurality of tank models 1 . . . 1 differing in performance. Information characteristic to each tank model 1 is recorded in the vehicle recognition ROM 3. A specific tank model 1 can be controlled by only a transmitter 2 having a vehicle recognition ROM 3 on which information characteristic to the tank model 1 is recorded. For example, a tank A can be controlled by only a transmitter 2 having a vehicle recognition ROM 3 on which information characteristic to the tank A is recorded. On the contrary, another tank model, for example, the tank B can be controlled by replacing only a vehicle recognition ROM A3 on which characteristic information associated with the tank A is recorded in transmitters 2 . . . 2, with a vehicle recognition ROM B3 on which characteristic information of the tank B is recorded. Concrete contents of information characteristic to the tank model 1 recorded in the vehicle recognition ROM 3 will be described later.

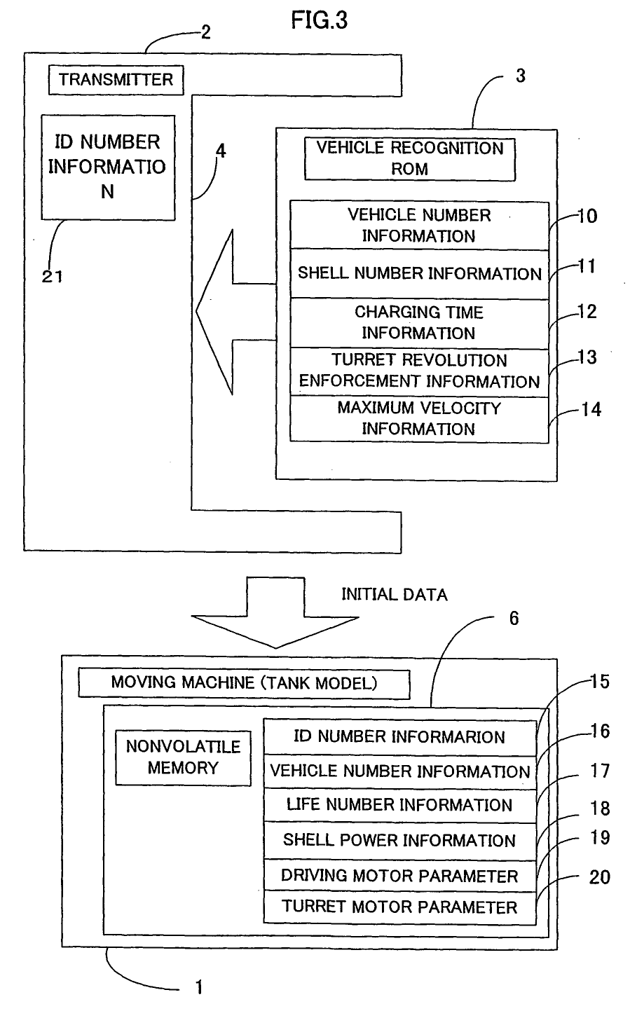

FIG. 3 is a diagram showing contents of data recorded in the vehicle recognition ROM 3 and the tank model 1 as information characteristic to the tank model 1, and showing a relation between those data and hardware 1 . . . 3 used in the present embodiment. In the tank model 1, a nonvolatile memory 6 is provided as a storage region on which information characteristic to the tank model 1 is recorded. ID number information 21 is provided in the transmitter 2.

First, data recorded in the vehicle recognition ROM 3 and the nonvolatile memory 6 will now be described.

In the present embodiment, vehicle number information 10, shell number information 11, charging time information 12, turret revolution enforcement information 13, and maximum velocity information 14 are recorded in the vehicle recognition ROM 3 as information characteristic to each tank model 1.

The vehicle number information 10 is a code for identifying the vehicle. For example, in the case of a vehicle recognition ROM A3 on which information characteristic to the tank A is recorded, a vehicle number of the tank A is recorded in the vehicle number information 10. In the present embodiment, this code is used as the second identification information. When the code does not coincide with the vehicle number of the tank model 1, therefore, the tank model 1 does not operate. The second identification information in the present invention is not limited to the vehicle number information 10, but needs only be information characteristic to the tank model 1. The shell number information 11, charging time information 12, turret revolution enforcement information 13, and maximum velocity information 14 are information concerning control laws characteristic to a tank model 1 specified by the vehicle number information 10. The shell number information 11 is an initial value of the number of shells of the tank model 1 specified by the vehicle number information 10. The charging time information 12 is time between firing of a shell and firing of the next shell. The shell number information 11 and the charging time information 12 are parameters for determining the performance of the tank model 1, but are managed by the transmitter 2. The reason why a part of information characteristic to the tank model 1 is managed by the transmitter 2 is that system complication is avoided and the production cost is suppressed. The turret revolution enforcement information 13 is a code for specifying whether turret revolution should be enforced. On the basis of the data, it can be determined whether a specific control member of the transmitter 2 is intended for firing or turret revolution. The maximum velocity information 14 is a value for setting the maximum velocity of the tank model 1 specified by the vehicle number information 10.

Data recorded on the vehicle recognition ROM 3 in the present embodiment has heretofore been described. Information concerning control laws characteristic to a tank model 1 specified by the vehicle number information 10 is not limited to them. Therefore, various variations of the tank model 1 are made possible, and customizing or version up is also made possible without changing the design of the transmitter 2.

On the other hand, in the present embodiment, ID number information 15, vehicle number information 16, life number information 17, shell power information 18, a driving motor parameter 19 and a turret motor parameter 20 are recorded on the nonvolatile memory 6 incorporated in the tank model 1.

The ID number information 15 is ID number information of a tank model 1 (hereafter referred to as “pertinent tank model 1”) having the nonvolatile memory 6. The vehicle number information 16 is a code for recognizing a vehicle number, and it is a vehicle number of the pertinent tank model 1. If the code does not coincide with vehicle number information 10 that the vehicle recognition ROM 3 has, then the pertinent tank model 1 is not activated by a transmitter 2 having the vehicle recognition ROM 3 mounted thereon. The life number information 17 is an initial value of an attack permissible value of the pertinent tank model 1. The shell power information 18 is a value that indicates power of a main gun fired from the pertinent tank model 1. The life number information 17 and the shell power information 18 are items included in parameters that determine the performance of the pertinent tank model 1 and managed on the tank model 1 side. The driving motor parameter 19 and the turret motor parameter 20 are motor control parameters with due regard to dispersion caused at the time of mass production.

A method for discriminating a transmitter by using the characteristic information will now be described. If a vehicle recognition ROM 3 having characteristic information 10 . . . 14 of a specific tank model 1 recorded thereon is mounted on a transmitter 2, then initial data is transmitted from the transmitter 2. The initial data is transmission data created by the transmitter 2 to bring the tank model 1 into a state in which the tank model 1 can operate. The initial data includes the vehicle number information 10 stored in the pertinent vehicle recognition ROM 3 and the ID number information 21. If the ID number information 15 and the vehicle number information 16 of the tank model 1 that has received the initial data coincide with the contents of the initial data, then the pertinent transmitter 2 is distinguished as a transmitter that can remote-control the pertinent tank model 1 and the pertinent tank model 1 comes into a state in which it can operate. The initial data may include data concerning initial setting of the tank model 1, besides the ID number information 21 and the vehicle number information 10.

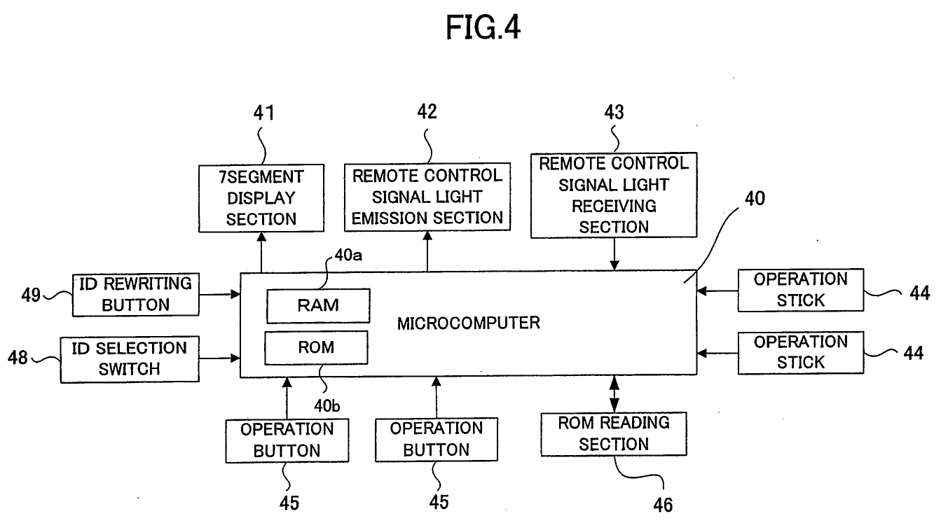

FIG. 4 shows a circuit configuration of the transmitter 2 in the present embodiment. The transmitter 2 has a microcomputer 40 for controlling sections 41 . . . 49 of the transmitter 2. In the microcomputer 40, a RAM 40a serving as a temporary storage region is provided. A ROM reading section 46 is connected to the microcomputer 40. The data 10 . . . 14 recorded in the vehicle recognition ROM 3, which is mounted on the recording medium mounting section 4 are read by the ROM reading section 46, and temporarily recorded on the RAM 40a. In the microcomputer 40, a ROM 40b for recording fixed data, which do not change according to the vehicle kind of the tank model 1, and a program are also provided.

Besides, a structure for remote-controlling the tank model 1 is connected to the microcomputer 40. A 7 segment display section 41 displays the state of the transmitter 2. A remote control signal light emission section 42 converts data to be transmitted to an optical signal and transmits the optical signal. A remote control signal light receiving section 43 receives an optical signal transmitted from another transmitter 2. Operation sticks 44 . . . 44 and operation buttons 45 . . . 45 are structures for operating the tank model 1, such as buttons for firing the main gun and sticks for revolving the turret. An ID selection switch 48 is a switch for setting the ID number information 21 of the transmitter 2. An ID rewriting button 49 is a button for rewriting the ID number information 15 of the movable machine 1 so as to become the same as its own ID number information 21. The ID number information 21 set by the ID selection switch 48 or the ID rewriting button 49 is recorded on the RAM 40a.

The microcomputer 40 creates initial data including the vehicle number information 10 and the ID number information 21 recorded temporally in the RAM 40a, converts such data to an optical signal, and transmits the optical signal from the remote control signal light emission section 42 to the tank model 1.

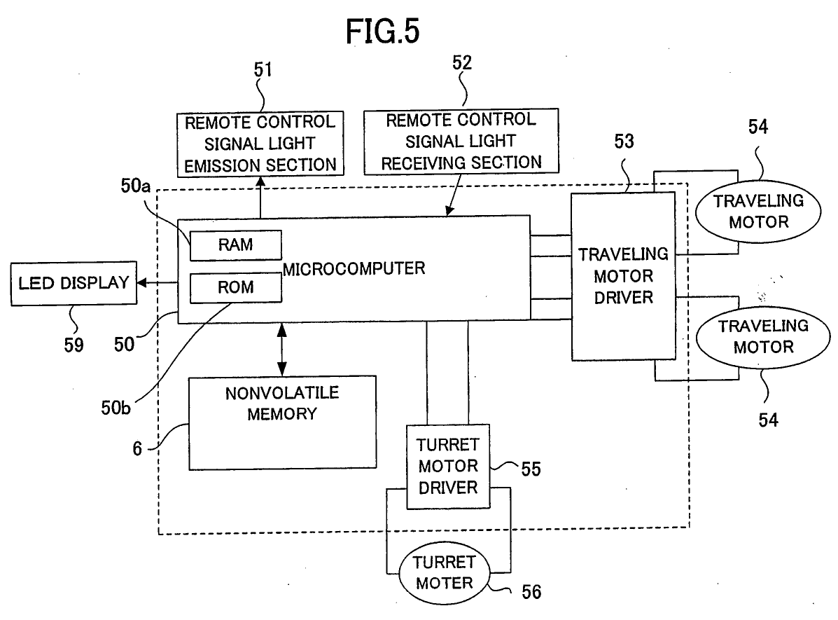

FIG. 5 shows a circuit configuration of the tank model 1 in the present embodiment. The tank model 1 includes a microcomputer 50 for controlling its own operation. In the microcomputer 50, a RAM 50a serving as a temporary storage region and a ROM 50b for recording data common to all vehicle kinds and a program are provided. The nonvolatile memory 6 on which the information 15 . . . 20 characteristic to the tank model 1 is recorded as described above is connected to the microcomputer 50.

Besides, structures required for the remote control and the operation of the tank model 1 are connected to the microcomputer 50. A remote control signal light emission section 51 converts information concerning firing to an optical signal and transmits the optical signal. A remote control signal light receiving section 52 receives an optical signal transmitted from the transmitter 2 or another tank model 1. As structures required for its own operation, there are structures 53 . . . 54 concerning the traveling motor and structures 55 . . . 56 concerning the turret motor. A LED display 59 emits light to notify the outside of the state of the tank model 1.

The microcomputer 50 receives initial data at the remote control signal light receiving section 52, reads out the ID number information 21 and the vehicle number information 10 contained in the initial data into the RAM 50a, and determines whether they coincide with its own ID number information 15 and vehicle number information 16. In the case of coincidence, a reception enabling flag retained in the RAM 50a of the microcomputer 50 is set. The reception enabling flag is a discriminant indicating whether the tank model 1 is ready to be activated by ordinary remote control. Since it is needed only to determine whether the tank model 1 is ready to be activated, 1 bit suffices.

A flow of actual processing of the remote control system having the above described configuration example will now be described by taking the case where a fighting game is played among a plurality of tank models 1 . . . 1 differing in performance.

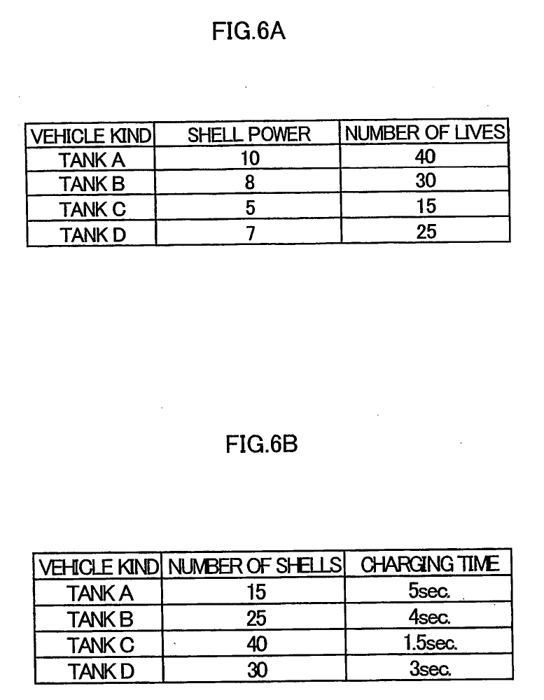

FIGS. 6A and 6B are tables showing examples of performance concerning firing of tanks A to D as an example of tank models 1 . . . 1 differing in performance. FIG. 6A shows data retained by the nonvolatile memory 6, which is incorporated in each tank model 1. FIG. 6B shows data retained by the vehicle recognition ROM 3 corresponding to each tank model 1. For example, besides the vehicle number information 16 of the tank A, therefore, the information that the shell power information 18 is 10 and the life number information 17 is 40 is recorded in the nonvolatile memory 6 of the tank A. Besides the vehicle number information 10, the information that the shell number information 11 is 15 and the charging time information 12 is 5 seconds is recorded in the vehicle recognition ROM A3 having information characteristic to the tank A recorded thereon.

First of all, it is confirmed that the transmitter 2 and the controlled tank model 1 respectively have the same ID number information 15,21 set therein. A vehicle recognition ROM A3 having information characteristic to the controlled tank model 1, such as, for example, information characteristic to the tank A when the tank A is controlled, recorded therein is mounted on the transmitter 2.

After the vehicle recognition ROM 3 has been mounted on the transmitter 2, a circuit for power supply of the tank model 1 is thrown in. The tank model 1 does not operate until an initialization processing is finished. Here, the initialization processing of the tank model 1 refers to processing conducted until reception of a control signal from a transmitter 2 associated with the tank model 1 is enabled and it becomes possible to conduct remote control. Subsequently, a circuit for power supply of the transmitter 2 is thrown in.

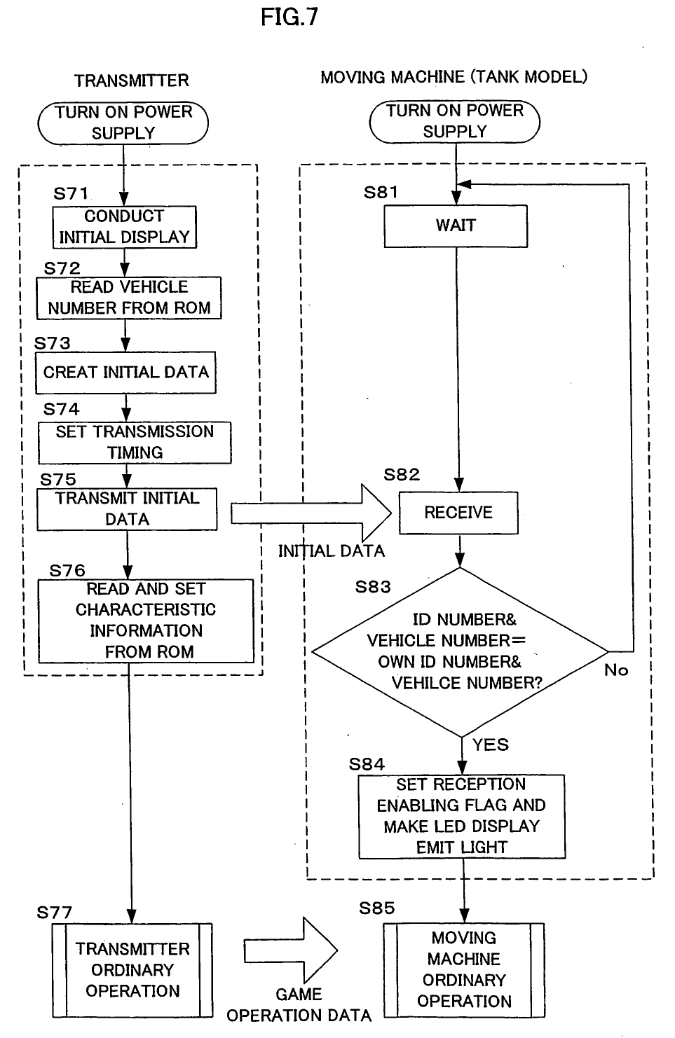

FIG. 7 is a diagram showing a flow of processing conducted after the circuit for power supply of each of the tank model 1 and the transmitter 2 is thrown in. The processing flow in the tank model 1 are shown in steps S81 to S85. The processing flow in the transmitter 2 are shown in steps S71 to S77.

If the circuit for power supply of the tank model 1 is thrown in, then the tank model 1 assumes an initial data reception waiting state (step S81). The tank model 1 waits until it receives initial data having ID number information 21 and vehicle number information 10 that coincide with the its own ID number information 15 and its own vehicle number information 16. In the waiting state, the tank model 1 is not activated by any game operation data. The game operation data is moving data for conducting ordinary remote control. The game operation data refers to data that include not only the ID number information 21 of the transmitter 2 but also control data for making the tank model 1 operate. is the data for conducting the normal remote control,

On the other hand, if the circuit for power supply of the transmitter 2 is thrown in, then initial display is conducted, in which a state of conducting initial setting is indicated on a 7 segment display section 41 (step S71). Subsequent steps S72 to S76 are initialization processing in the transmitter 2. The initial display displayed at the step S71 is displayed until the processing proceeds to the ordinary operation of step S77. After the initial display has been displayed at the step S71, the processing proceeds to the step S72. At the step S72, the microcomputer 40 of the transmitter 2 reads the vehicle number information 10 from the vehicle recognition ROM 3 by using the ROM reading section 46, and records the vehicle number information 10 in the RAM 40a, and the processing proceeds to step S73. At the step S73, initial data containing the ID number information 21 and the vehicle number information 10 recorded on the RAM 40a is created. Subsequently, the processing proceeds to step S74, where transmission timing for transmitting data from the transmitter 2 is set. When there is already another transmitter 2 that transmits game operation data with the same ID number information 21, then crosstalk occurs with the ID number information 21 as described above and the normal remote control cannot be conducted. In this case, therefore, it becomes necessary to rewrite the ID number information 21. Since processing of setting a series of transmission timing is similar to that in the already disclosed remote control system using infrared arrays, detailed description will be omitted.

If the transmission timing is determined, then the initial data created at the step S73 is transmitted to the tank model 1 (step S75). In the transmitter 2 after the transmission of the initial data, the data 11 . . . 14 characteristic to the tank model 1 recorded in the vehicle recognition ROM 3 are read out, and respective values are set in respective variables and recorded in the RAM 40a of the microcomputer 40. For example, the value of the shell number information 11 is set in a variable that indicates the number of shells the tank model 1 has at the beginning. In the same way, each of the characteristic data 12 . . . 14 is set, and then the initialization processing in the transmitter 2 is finished.

Upon receiving the initial data (step S82), the tank model 1 proceeds to step S83, and determines whether the ID number information 21 and the vehicle number information 10 contained in the received initial data coincide with the ID number information 15 and the vehicle number information 16 recorded in its own nonvolatile memory 6. If coincidence is found in both kinds of information, then the tank model 1 judges the initial data to be initial data supplied from the transmitter 2 that should control the tank model 1 itself, and proceeds to step S84. Otherwise, the tank model 1 returns to the initial data waiting state of the step S81. At the step S84, the reception enabling flag is set. In the present embodiment, the reception enabling flag has one bit. Therefore, the reception enabling flag is changed, for example, from 0 to 1. After the reception enabling flag is set, the LED display 59 is made to emit light and the initialization processing of the tank model 1 is finished.

If the initialization processing is finished in the transmitter 2 and the tank model 1, then the tank model 1 comes into a state in which it can operate, and the ordinary remote control using the transmitter 2 becomes possible (steps S77 and S85). In other words, it becomes possible to control the tank model 1 by using the ordinary game operation data transmitted from the transmitter 2. It becomes possible for the tank model 1 to participate in the fighting game.

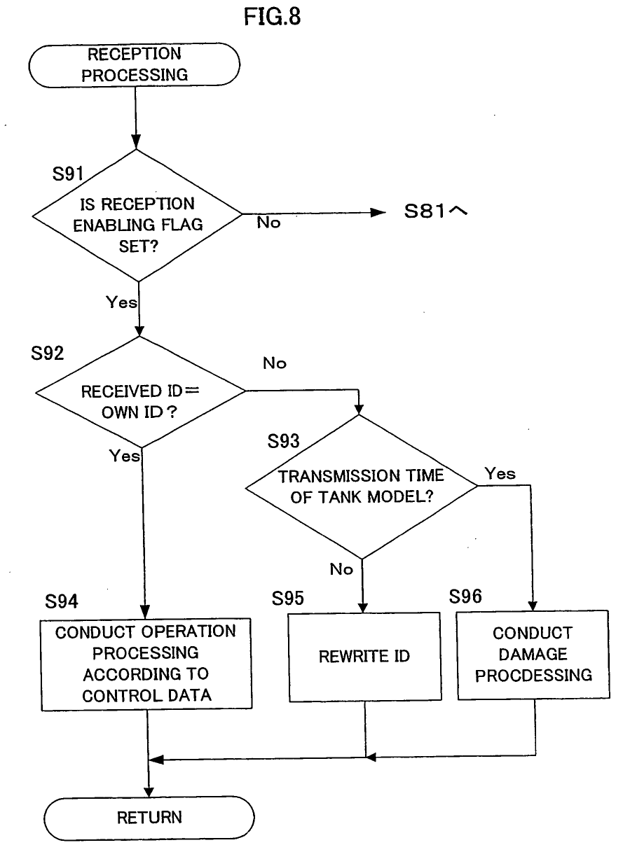

A processing flow in the ordinary remote control of the tank model 1 at the step S85 is shown in FIG. 8. Upon receiving the game operation data, the tank model 1, that is, the microcomputer 50 first determines at step S91 whether the reception enabling flag in its own RAM 50a is in the set state. If the reception enabling flag is judged to be not in the set state, then the tank model 1 judges its own initialization processing to be not finished, disregards the received game operation data, and returns to the reception waiting state of the step S81. If the tank model 1 judges the reception enabling flag to be in the set state, then the tank model 1 judges itself to be ready to operate and proceeds to step S92. At the step S92, the tank model 1 determines whether the ID number information 21 contained in the received game operation data coincides with the ID number information 15 recorded in the nonvolatile memory 6. If the tank model 1 judges them to coincide with each other, then the tank model 1 judges the game operation data to be that supplied from the transmitter 2 that should control the tank model 1 itself and proceeds to step S94, where the tank model 1 operates according to the control data contained in the game operation data. If there is already a transmitter 2 that is conducting the remote control with the same ID number information 21, then a transmitter 2 other than the transmitter 2 that has transmitted the initial data cannot control the tank model 1 by using that ID number information 21. If the ID number information 21 of received data is the same as the own ID number information 15, therefore, then the game operation data can be judged to have been transmitted from the transmitter 2 that transmitted the initial data received at the step S82.

If the ID number information 15 is judged not to coincide with the ID number information 21, then the tank model 1 proceeds to step S93 and determines whether transmission time of the other tank models 1 . . . 1 is reached. If the tank model 1 judges transmission time of one of the other tank models 1 . . . 1 to have been reached, then the tank model 1 judges the received data to be firing data transmitted from the one of the other tank models 1 . . . 1, and proceeds to step S96 where damage processing is conducted. If the tank model 1 judges transmission time of the other tank models 1 . . . 1 to have not been reached, then the tank model 1 judges the received data to be an ID rewriting order transmitted from the transmitter that should control the tank model 1, and proceeds to step S95 where rewriting processing of the ID number information 15 is conducted.

Since the ordinary operation of the transmitter 2 conducted at the step S77 is not different from that of the already disclosed conventional remote control system using infrared rays, its description will be omitted.

The present invention is not limited to the above described embodiment, but may be embodied in various forms.

For example, in the above described embodiment, the mode in which the tank models 1 . . . 1 differing in performance are made to fight has been described. Besides such a mode, a mode fixed in all performances such as shell power and the number of shells, or a practice mode having no restrictions on these items may be selected.

In the present embodiment, the vehicle recognition ROM 3 separated from the tank model 1 is used as a recording medium having characteristic information of the tank model 1 recorded thereon. However, the form and size are not limited to this. Furthermore, also when characteristic information of the tank model 1 itself is retained in the tank model 1 as invisible information, the present invention can be implemented. For example, a method of determining whether a combination of the pertinent tank model 1 and a transmitter 2 is right or wrong by transmitting the characteristic information retained in a memory built in the tank model 1 from the tank model 1 to the transmitter 2, a method of determining whether a combination of the pertinent tank model 1 and a transmitter 2 is right or wrong by making the tank model 1 incorporate an IC chip having characteristic information of the tank model 1 recorded therein to make the transmitter 2 read the contents of the IC chip, and a method of determining whether a combination is right or wrong by recording characteristic information of the tank model 1 in the tank model 1 as a bar code to make the transmitter 2 read are also included in the present invention.

Furthermore, in the present embodiment, an EEPROM is used as each of the vehicle recognition ROM 3 and the nonvolatile memory 6, but the vehicle recognition ROM 3 and the nonvolatile memory 6 are not limited to this so long as the recording medium can prevent easy writing.

In the present embodiment, the one-bit reception enabling flag is used as the method of determining whether the tank model 1 is ready to operate, but the determining method is not limited to this.

Furthermore, in the present embodiment, the remote control is conducted by only using the ID number information 15,21 as keys after the tank model 1 has come into such a state that the tank model 1 can operate. The game operation data transmitted from the transmitter 2 may include the vehicle number information 10. While the ID number information 15,21 is in a range of 1 to 4, it may be greater or less than it.

As heretofore described, the present invention provides a remote control system that prevents a combination of a transmitter and a movable machine in the remote control system other than a combination determined in the system from being established, excludes unfairness in fighting games, and is capable of easily discriminating a movable machine and a transmitter combined in the system even when combinations cannot be discriminated visibly.

1. A remote control system comprising:
a transmitter; and
a movable machine remote-controlled on the basis of a control signal transmitted from the transmitter, and discriminating at least one combination of the transmitter and the movable machine to be controlled by the transmitter on the basis of first identification information transmitted from the transmitter,
wherein the remote control system comprises a recording medium having characteristic information associated with the movable machine recorded thereon,
the transmitter comprises:
a characteristic information recognition device for recognizing the characteristic information concerning the movable machine to be controlled, recorded on the recording medium; and
a second identification information transmission device for transmitting second identification information, which specifies the movable machine to be controlled on the basis of the recognized characteristic information, and
the movable machine comprises:
a discrimination device for determining whether remote control conducted by the transmitter that has transmitted the second identification information is allowed, on the basis of the received second identification information; and
a remote control prohibition device responsive to discrimination that the remote control is not allowed, for prohibiting the remote control by the transmitter that has transmitted the second identification information, irrespective of whether the combination based on the first identification information is established.

2. The remote control system according to claim 1, wherein the recording medium is detachably attached to the transmitter.

3. The remote control system according to claim 1, wherein writing into the recording medium is not conducted by users.

4. The remote control system according to claim 1, wherein
the movable machine comprises a storage device for storing information based on the characteristic information associated with itself, and
the discrimination device determines whether the remote control is allowed on the basis of the stored information based on the characteristic information of itself and the received second identification information.

5. The remote control system according to claim 1, wherein the movable machine comprises a remote control enabling device for enabling the movable machine to be remote-controlled on the basis of the first identification information after the discrimination device has judged the remote control to be allowed.

6. The remote control system according to claim 5, wherein
the movable machine comprises a discriminant for determining whether the movable machine should operate on the basis of the control signal, and
the remote control enabling device enables the remote control on the basis of the first identification information, by controlling the discriminant.

7. The remote control system according to claim 5, further comprising:
a transmitter excluding device for disabling the remote control conducted by another transmitter except for the transmitter enabled first by the discrimination device, even if the other transmitter is the transmitter to control the movable machine on the basis of the first identification information.

8. The remote control system according to claim 7, wherein the transmitter excluding device disables the remote control conducted by the other transmitter, by using information based on transmission timing of the control signal transmitted by the transmitter.

9. The remote control system according to claim 1, wherein
the characteristic information comprises information concerning control laws characteristic to the movable machine associated with the characteristic information, and
the transmitter comprises a control signal transmission device for creating a control signal based on the control laws and transmitting the created control signal.

10. A movable machine moved by a control signal supplied from a transmitter, which is combined with the movable machine on the basis of first identification information, the movable machine comprising:
a recording medium having characteristic information of the movable machine itself recorded thereon;
a discrimination device responsive to transmission of second identification information based on the characteristic information transmitted from the transmitter that has recognized the characteristic information through the recording medium, for determining whether remote control conducted by the transmitter that has transmitted the second identification information is allowed, on the basis of the received second identification information; and
a remote control prohibition device responsive to discrimination that the remote control is not allowed, for prohibiting the remote control by the transmitter that has transmitted the second identification information, irrespective of whether a combination based on the first identification information is established.

11. The movable machine according to claim 10, wherein the recording medium can be separated from the movable machine.

12. The movable machine according to claim 10, wherein the discrimination device determines whether the remote control conducted by the transmitter that has transmitted the second identification information is allowed, on the basis of information based on the characteristic information of itself and the received second identification information.

13. A transmitter for remote-controlling a movable machine combined as a control object with the transmitter subject on the basis of first identification information, the transmitter comprising:
a characteristic information recognition device for recognizing characteristic information of the movable machine recorded on a recording medium; and
a second identification information transmission device for transmitting second identification information, which specifies the movable machine to be controlled, on the basis of the recognized characteristic information.

14. A remote control system comprising:
a transmitter and a movable machine remote-controlled on the basis of a control signal transmitted from the transmitter,
wherein the remote control system comprises a recording medium having characteristic information associated with the movable machine recorded thereon,
the transmitter comprises:
a characteristic information recognition device for recognizing the characteristic information associated with the movable machine to be controlled; and
a movable machine specification information transmission device for transmitting movable machine specification information that specifies the movable machine to be controlled, on the basis of the recognized characteristic information, and
the movable machine comprises:
a discrimination device for determining whether remote control conducted by the transmitter that has transmitted the movable machine specification information is allowed, on the basis of the received movable machine specification information; and
a remote control prohibition device responsive to discrimination that the remote control is not allowed, for prohibiting the remote control by the transmitter that has transmitted the movable machine specification information.

15. The remote control system according to claim 14, wherein the recording medium is detachably attached to the transmitter.

16. The remote control system according to claim 14, wherein
the characteristic information comprises information concerning control laws characteristic to the movable machine associated with the characteristic information, and
the transmitter comprises a control signal transmission device for creating the control signal based on the control laws and transmitting the created control signal.

17. A movable machine moved by a control signal supplied from a transmitter, the movable machine comprising:
a recording medium having characteristic information of the movable machine itself recorded thereon;
a discrimination device responsive to transmission of identification information based on recognized characteristic information transmitted from the transmitter that has recognized the characteristic information from the recording medium, for determining whether remote control conducted by the transmitter that has transmitted the identification information is allowed, on the basis of received identification information; and
a remote control prohibition device responsive to discrimination that the remote control is not allowed, for prohibiting the remote control by the transmitter that has transmitted the identification information.

18. The movable machine according to claim 17, wherein the recording medium is detachably attached to the movable machine.

19. The movable machine according to claim 17, wherein the discrimination device determines whether the remote control conducted by the transmitter that has transmitted the identification information is allowed, on the basis of information based on the characteristic information of itself and the received identification information.

20. A transmitter for remote-controlling a movable machine, the transmitter comprising:
a characteristic information recognition device capable of recognizing characteristic information of the movable machine recorded on a recording medium; and
an identification information transmission device for transmitting identification information, which specifies the movable machine to be controlled on the basis of the recognized characteristic information.
